(19) United States
(12) Patent Application Publication
(10) Pub. No.: US 2006/0196227 A1
(43) Pub. Date: Sep. 7, 2006

(54) Method of producing foamed slag

(76) Inventors: Djamschid Amirzadeh-Asl, Moers (DE); Dieter Funders, Duisburg (DE)

Correspondence Address: FULBRIGHT & JAWORSKI, LLP, 666 FIFTH AVE, NEW YORK, NY, 10103-3198, US

(21) Appl. No.: 11/405,291

(22) Filed: Apr. 17, 2006

Related U.S. Application Data
(63) Continuation of application No. 09/980,037, filed on Sep. 11, 2002, now abandoned.

(30) Foreign Application Priority Data
Jun. 2, 1999 (DE) 199 25 144.4

(51) Int. Cl. C03B 19/08

(52) U.S. Cl. 65/20

(57) ABSTRACT

A method of producing foamed slag in an arc furnace by measured blowing of a carbon carrier by means of an oxygen carrier into the boundary layer between the slag and molten metal layers or into zones of the slag or molten metal layer adjacent to the boundary layer in an amount such that arcs are enveloped at least by a foamed slag layer.

The invention relates to a method of producing foamed slag in an arc furnace by the measured blowing of a carbon carrier by means of an oxygen carrier into the boundary layer between the slag layer and the molten metal and/or into the zones of the slag layer and/or of the molten metal that are adjacent to the boundary layer, in an amount such that the arcs are enveloped at least partially by a foamed slag layer.

The arc furnace which is used for melting metals and for producing high-quality steels uses the heat effect of an arc between a plurality of graphite electrodes either indirectly by heating the material to be melted only by the radiation of the arc, or by the material to be melted itself acting as an electrode of the arc. In addition to the arc, a further energy component is introduced by blowing finely divided carbon carriers together with oxygen carriers into the molten metal or into the slag layer. In addition, in order to form a foamed slag layer on the molten metal, finely divided carbon carrier is blown into the boundary layer between the slag layer and the molten metal, which boundary layer is substantially made up of the components iron oxide, calcium oxide, silicon dioxide, aluminium oxide and magnesium dioxide. The graphite electrodes, or the arc, and the furnace wall are enveloped by the foamed slag layer in such a manner that direct heat radiation at the furnace walls and at the furnace cover is largely avoided. A suitable proportion of carbon carrier and oxygen carrier must be present in order to foam the slag by the formation of CO/CO₂ bubbles. The high proportion of gas bubbles in the slag also reduces the direct conduction of heat in the foamed slag layer itself. The graphite electrodes immersed in the foamed slag layer, or the arcs between the molten metal and the graphite electrodes, are largely protected by the foamed slag layer against the ingress of free oxygen from the atmosphere, so that the rate of combustion is reduced and the working life of the arc furnace is increased. In addition, the graphite electrodes are sometimes also sprayed with water in order to reduce the heat load and hence the rate of combustion.

The production of a foamed slag layer for covering the arcs in arc furnaces is described in DE-Z.: Stahl und Eisen, 106 (1986), No. 11, p. 625 to 630.

In order to ensure the advantages of an arc enveloped in foamed slag over a long period of time with minimum outlay, according to EP-A-0 637 634 level measurement of the height of the slag layer is carried out several times on a furnace charge and, by blowing solids, gases or a mixture of solids and gases into and/or onto the slag or the molten metal, a foamed slag layer enveloping an arc formed by at least one electrode is formed, the height of which foamed slag layer is such that the foamed slag layer extends at least over the entire arc.

There is also known a method or a device for controlling the formation of foamed slag in an arc furnace, to which carbon is fed in such a manner that the arc in the arc furnace is enveloped at least partially and, at the same time, the supply of an excessive amount of carbon is avoided. The amount of carbon fed to the arc furnace is determined by means of a foamed slag model, which is dependent on the amount of at least one of the charge materials scrap metal, steel, alloying agent or additives (DE-C-197 48 310).

The object of the present invention is to develop the method described at the beginning in such a manner that the protective function of the foamed slag layer is improved.

That object is achieved by blowing into the arc furnace finely divided titanium carrier, preferably having a mean particle size d₅₀ of from 0.001 to 1.0 mm and a particle size of up to 5.0 mm.

Both natural and synthetic titanium carriers may be used. However, natural titanium carriers have the disadvantage over synthetic titanium carriers that only relatively coarse-grained particles of up to 100 mm are available. Owing to their specific properties, natural titanium carriers have a highly abrasive action on the feed system and the blowing-in device, so that the blowing in of natural titanium carriers leads to frequent stoppages and, consequently, to high repair costs. In addition, the chemical and physical parameters can vary considerably in the case of natural titanium carriers, so that they cannot be used, or can be used only with considerable risks, in the manufacture of steel of which high demands are made in terms of quality.

Because of the greater fineness of the particles of synthetic titanium carriers, advantages arise not only with regard to negligible wear of the blowing-in device, but also in that the course of the desired reactions is accelerated kinetically because of the larger specific surface area of the comparatively finer particles of the synthetic titanium carrier.

The synthetic titanium carriers introduced may consist of pure titanium dioxide, whose particles have a mean particle size at 100% of up to 200 μm.

A preferred embodiment of the method according to the invention consists in the use of synthetic titanium carrier that contains, in addition to titanium dioxide, up to 95 wt. %, preferably from 20 to 80 wt. %, iron oxides such as Fe₂O₃, FeO₂, Fe₃O₄.

The titanium carrier can also contain one or more of the components calcium oxide, silicon oxide, aluminium oxide and magnesium oxide.

Because of the fineness of the particles and the large specific surface area, the iron-oxide-containing titanium carrier blown into the arc furnace melts immediately. In conjunction with the carbon blown in at the same time, both the iron oxide and the titanium dioxide are immediately reduced to elemental iron and titanium. The reduced titanium dissolves in the metallic iron droplets and reacts immediately thereafter with the carbon which is present in excess and is likewise dissolved in the fine iron droplets, to form titanium carbide. Because of the extremely high temperatures of an arc of up to 3000° C., the content of nitrogen in the atmosphere and hence also in the liquid slag layer and the molten metal is frequently concentrated. If the fine, molten iron droplets enriched with titanium come into contact with the slag and molten metal enriched with nitrogen, titanium nitride and titanium carbonitride form which, like titanium carbide, are extremely highly refractory and resistant to attack by oxygen and have very high resistance to physical erosion and chemical corrosion.

The formation of those titanium compounds is a pure phase boundary reaction and takes place especially at the surface of the iron droplets. As a result, a dense layer of those titanium compounds is formed at the surface of the droplets. The titanium compounds are immediately deposited on the contact surfaces, that is to say the furnace lining and/or the graphite electrodes, during foaming of the slag. The iron droplets then freed of the titanium compounds slowly sink into the molten steel owing to their higher specific weight.

The pure crystals, once deposited on the surface of the furnace lining and/or the graphite electrodes, increasingly grow together to form complex wear-resistant titanium compounds and form a permanent layer that is resistant to corrosion and erosion even when the foamed slag collapses and frees the surface to be protected again. Because of the high grain fineness, the titanium compounds formed can be introduced by macroscopic transport processes into the porous surfaces of the furnace lining and/or of the graphite electrodes, and in some cases they also diffuse into the tiny pores. The optimum closure of the micropores prevents further penetration of slag and gases and thus protects deep into the furnace lining and/or the graphite electrodes.

The advantages achieved with the invention are especially that the finely divided titanium carriers can be introduced without difficulty into the arc furnace, alone or in admixture with carbon carriers, and, owing to their large specific surface area, cause a very rapid reaction kinetics. The content of titanium carrier, based on the carbon content, is from 1 to 80%. Within a short time, highly refractory, corrosion- and erosion-resistant titanium carbides, titanium nitrides and titanium carbonitrides form, which are deposited on the surface of the furnace lining and the graphite electrodes and in some cases diffuse into the coarse inner pores; a layer of intergrown crystals of different titanium compounds forms, ensuring permanent protection even after the foamed slag layer has collapsed.

It is also advantageous that, if required, the titanium carriers can be blown in locally in the region of an area of damage that is to be repaired.

1-4. (canceled)

5. A method for producing foamed slag in an arc furnace comprising blowing a carbon carrier with an oxygen carrier into a boundary layer between a slag layer and a molten metal, or into a zone of the slag layer or a molten metal that are adjacent to the boundary layer, in an amount such that arcs are enveloped at least partially by said foamed slag layer, and blowing in a finely divided titanium carrier having a mean particle size d₅₀ of from 0.001 to 1.0 mm and a grain size of up to 5 mm, wherein the titanium carrier is introduced in admixture with said carbon carrier and the content of titanium carrier, based on the carbon content, is from 1 to 80%.

6. The method according to claim 5, wherein said titanium carrier has a titanium dioxide content of from 5 to 100% by weight.

7. The method of claim 6, wherein said titanium carrier has a titanium dioxide content of form 20 to 80% by weight.

8. The method according to claim 5, wherein the titanium carrier comprises up to 95 wt. % iron oxide.

9. The method according to claim 5, wherein the titanium carrier comprises from 20 to 80 wt. % iron oxide.

10. The method according to claim 5, wherein the titanium carrier contains at least one oxide selected from the group consisting of calcium oxide, silicon oxide, aluminum oxide and magnesium oxide.

11. The method according to claim 6, wherein the titanium carrier contains at least one oxide selected from the group consisting of calcium oxide, silicon oxide, aluminum oxide and magnesium oxide.

12. The method according to claim 5, wherein the titanium carrier consists of pure titanium dioxide.

13. The method according to claim 5, wherein the particles of titanium carrier have a mean at 100% of up to 200 microns.
